(19) United States
(12) Patent Application Publication
(10) Pub. No.: US 2026/0125066 A1
(43) Pub. Date: May 7, 2026

(54) CONTROL SYSTEM FOR A DUMP VEHICLE

(71) Applicant: Federal Signal Corporation, Downers Grove, IL (US)

(72) Inventors: James Erickson, Mankato, MN (US); Kollin Joines, LeSueur, MN (US)

(21) Appl. No.: 19/381,336

(22) Filed: Nov. 6, 2025

Related U.S. Application Data
(60) Provisional application No. 63/717,048, filed on Nov. 6, 2024.

(51) Int. Cl. B60W 50/00; B60P 1/04; B60W 10/30; B60W 30/14; B60W 40/12; G01C 9/02

(52) U.S. Cl. CPC B60W 50/0098; B60P 1/04; B60W 10/30; B60W 30/146; B60W 40/12; G01C 9/02; B60W 2300/12; B60W 2520/10; B60W 2530/201; B60W 2710/30; B60W 2720/10

(57) ABSTRACT

The present disclosure describes a control system for a dump vehicle. The control system includes a controller configured to receive a first input associated with a height limit of the dump truck, receive a second input to raise a dump body of the dump truck, and generate a first signal in response to the first input. The controller is further configured to receive second signals. Based on the second signals, the controller is further configured to calculate a height of the dump truck to provide a calculated height, compare the calculated height to the height limit, and when the calculated height reaches the height limit, generate a third signal configured to cause actuation of an interlock that prevents further raising of the dump body by the hoist.

### FIELD OF DISCLOSURE

The present disclosure is directed to a control system for a dump vehicle.

### BACKGROUND

Construction often requires dump trucks to carry debris, dirt, and other material to and from the construction site. Dump trucks provide the capability to haul the material either to the construction site or a remote site. These vehicles are designed to better handle the extreme weight from the amount of material that is often needed to be transported. For example, dump trucks often include an extra axle for better distribution of its weight while hauling material. Further, dump trucks include a dump body (also referred to as a dump bed) that is hydraulically operated to lift at an angle relative to a chassis of the dump truck. Lifting the dump body causes material to roll or slide out of the body and onto the ground or into a vessel or another vehicle below.

Construction sites often have overhead hazards. For example, many construction sites have power lines at high voltages that overhang. Contacting these power lines can lead to electrocution and death. Construction workers and equipment operators must be constantly aware of these lines to avoid contacting them. Even so, accidents still occur where equipment contacts the power line, which sends large amounts of current through the equipment. Other height clearance hazards, such as an overpass, another construction vehicle (e.g., a crane) or a building, may also be present. Dump trucks are especially susceptible to this risk of contacting the overhead dangers due to the dump body raising upwards resulting in a variable height.

### SUMMARY

Aspects of the present disclosure relate to improvements to a control system for a dump vehicle.

Aspects of the present disclosure relate to improvements in controlling speed of a dump vehicle based on the position of the dump body.

Aspects of the preset disclosure relate to improvements controlling the height of a dump body of a dump vehicle.

According to certain specific aspects, the present disclosure relates to a control system for a dump truck. The control system includes a controller configured to receive a first input associated with a height limit of the dump truck, receive a second input to raise a dump body of the dump truck, and generate a first signal in response to the first input. The first signal is configured to cause a hoist of the dump truck to raise the dump body of the dump truck. The controller is further configured to receive second signals. Based on the second signals, the controller is further configured to calculate a height of the dump truck to provide a calculated height, compare the calculated height to the height limit, and when the calculated height reaches the height limit, generate a third signal configured to cause actuation of an interlock that prevents further raising of the dump body by the hoist.

According to additional aspects, the present disclosure relates to a dump truck. The dump truck includes a chassis, a dump body, a hoist configured to raise and lower a height of the dump body relative to the chassis, and a hoist actuator configured to selectively activate the hoist. The hoist actuator including an interlock. The dump truck further includes a control interface, a chassis inclinometer configured to indicate a first angle of the chassis of the dump truck relative to a direction of gravity, a dump body inclinometer configured to indicate a second angle of the dump body of the dump truck relative to the direction of gravity, and a controller. The controller is configured to receive, from the control interface, a first input associated with a height limit of the dump truck; receive, from the control interface, a second input to raise the dump body of the dump truck, and generate a first signal in response to the second input. The first signal is configured to cause the hoist actuator of the dump truck to activate the hoist to raise the dump body of the dump truck. The controller is further configured to receive second signals from the dump body inclinometer and the chassis inclinometer. Based on the second signals, the controller is further configured to calculate the height of the dump truck to provide a calculated height, compare the calculated height to the height limit; and when the calculated height reaches the height limit, generate a third signal configured to cause actuation of the interlock that prevents further raising of the dump body.

According to additional aspects, the present disclosure relates to a control system for a dump truck. The control system includes a controller configured to receive first signals indicating a dump body of the dump truck is raised and based on the first signals, generate second signals configured to cause a chassis engine control unit (ECU) of the dump truck to prevent the dump truck from exceeding a predetermined speed limit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures, wherein like numbers correspond to like parts, components, or features.

FIG. 1 depicts an example embodiment of a dump vehicle with a control system.

FIG. 2 depicts a block diagram of an example embodiment of the control system of FIG. 1.

FIG. 3 depicts a block diagram of a second example embodiment of the control system of FIG. 1.

FIG. 4 schematically depicts example physical components of the control system of FIG. 1.

FIG. 5 depicts an example control interface of FIG. 2 for providing input to the control system of FIG. 1.

FIG. 6 depicts a second example control interface of FIG. 2 for providing input to the control system of FIG. 1.

FIG. 7 depicts an example method for controlling the height of the dump body of the dump vehicle of FIG. 1 using the control system of FIG. 1.

FIG. 8 depicts an example method for controlling the speed of the dump vehicle of FIG. 1 using the control system of FIG. 1.

### DETAILED DESCRIPTION

Various embodiments will be described in detail with reference to the drawings.

Reference to various embodiments does not limit the scope of the claims attached hereto. Additionally, any examples set forth in this specification are not intended to be limiting and merely set forth some of the many possible embodiments for the appended claims.

The present disclosure relates to a control system for a dump vehicle, such as a dump truck. Dump vehicles are often used to transport material to and from construction sites. Construction sites often present unique challenges for dump vehicles. For example, many construction sites have overhanging power lines or an overpass, other equipment or structure that the dump vehicle is susceptible to hit with the dump body when it is in a raised position. Similarly, in moving to or from a construction site, a dump vehicle may encounter any number of overhead hazards even on an ordinary road that is not part of the construction site. If the dump vehicle were to hit the hazard, damage or injury can occur.

Embodiments of the present control system can overcome these challenges by accurately calculating a position of the dump body and/or limiting the speed responsive to a position determination of the dump body of the dump vehicle. In some embodiments, the control system receives a maximum height for the dump body above the ground. The control system calculates the angle of the dump body using an angle of the chassis to the ground and an angle of the dump body to ground. Then, the control system determines a height of the dump body. If the dump body is at the maximum height, then the control system will ignore inputs that attempt to raise the dump body. Accordingly, the control system prevents the dump body from contacting a hazard by remaining below a predetermined height. The predetermined height may be a minimum clearance height of a lowest hanging hazard at a location minus a safety factor.

In some embodiments, the control system increases safety of a dump vehicle by monitoring the position of the dump body and a speed of the dump vehicle. Operators who unload their dump truck while driving slowly with their dump body raised may forget their dump body is raised when they attempt to leave the dump site. To combat this danger, the control system monitors the position of the dump body. Responsive to determining that the dump body is in a raised position, the control system prevents the dump vehicle from exceeding a predetermined speed. Limiting the speed of the dump vehicle prevents the driver from reaching the desired speeds and can serve as reminder to the driver that the dump body is in a raised and unsafe position.

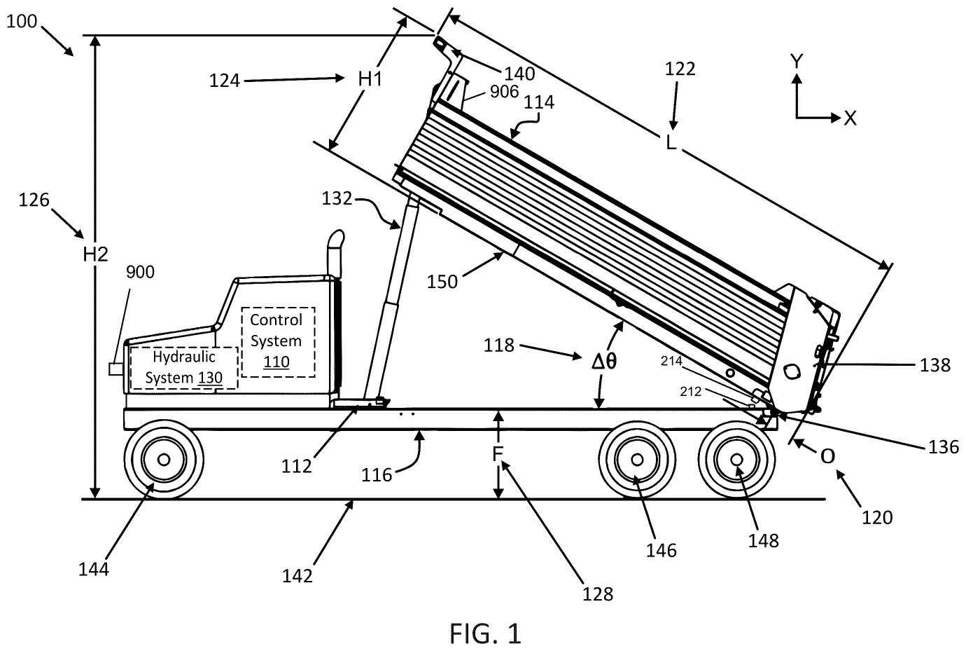

FIG. 1 depicts an example embodiment of a dump vehicle 100 with a control system 110. The dump vehicle includes a hoist actuator 112, a dump body 114, a chassis 116, and a hydraulic system 130. In the depicted example, the dump body 114 is in a raised position, such that the chassis 116 and the dump body 114 define an angle (Θ) 118. The dump body 114 defines a straight line distance (O) 120 from the rear end of floor panel of the dump body 114 to a hinge pin 136 of the dump vehicle 100. The dump body 114 also has a length (L) 122. The length (L) 122 extends from a top of a front wall 140 of the dump body 114 to a back gate 138 of the dump body 114. The dump body 114 also includes a height (H1) 124. The height (H1) 124 extends from the bottom side of a bottom panel 150 of the dump body 114 to the top of the front wall 140. The dump vehicle with the raised dump body also has a height (H2) 126. The height (H2) 126 extends from a ground 142 underneath a tire 144 of the dump body 114 to the top of the front wall 140 of the dump body 114. Further, the chassis 116 is at a height (F) 128 above the ground. The height (F) 128 measures from the surface of the ground 142 that contacts the tire 144, a tire 146, and a tire 148 to the top side of the chassis 116.

In some examples, the height (H2) 126 and the height (F) 128 are measured in the direction opposite the direction of the force of gravity, or they can be measured perpendicular to the surface of the ground 142. The height (H1) 124 is measured in the direction opposite the force of gravity when the dump body 114 is fully lowered and the front wall 140 is parallel to the force of gravity, or similarly measured perpendicular to the surface of the ground 142. The distance (O) 120 can be measured in the direction parallel to the surface of the ground 142 when the dump body 114 is fully lowered. The distance (O) is essentially a measurement of the dump body's overhang of the chassis when the dump body is in the fully lowered position.

The hoist actuator 112 connects to a hoist 132 that lifts the dump body 114.

The dump vehicle 100 can be used to transport loads of material. The material may be debris from a construction site, dirt, refuse, or other material that is to be transported to a different location. Further, the dump vehicle 100 can be a truck with two or more axles and wheels with tires attached to the axles. The dump vehicle 100 includes the hoist 132. The hoist 132 includes a large, powerful telescoping cylinder driven by a hydraulic piston that extends and retracts, pushing the dump body 114 up or allowing it to lower in a controlled manner under its own weight. The hoist 132 is positioned such that one end of the dump body 114 lifts up to use gravity to cause material within the dump body 114 to slide or roll out of the dump body 114. The hoist 132 may be positioned at different places on the chassis 116 to achieve different angles of lifting the dump body 114. In some embodiments, the hoist 132 is located underneath the dump body 114, connected to both the body and the truck's frame. The hinge pin 136 is the rod or axle that pivotally couples the dump body 114 to the chassis 116. The dump body 114 is, thus, enabled to hinge and pivot smoothly around the hinge pin 136. In some embodiments, the hinge pin 136 is placed in a different location. The distance (O) 120 is the distance measured in the X direction from the back of the dump body 114 floor panel to the center of the hinge pin 136 where the dump body 114 pivots as it is raised/lowered. The X direction measures along the length of the dump vehicle 100 from the front to the back. The Y direction measures along the height of the dump vehicle 100. A Z axis may also be included that measures along the width of the truck from side to side.

The hydraulic system 130 is also coupled to the hoist 132. The dump vehicle 100 uses hydraulic fluid of the hydraulic system 130 to control the hoist 132 that lifts the dump body 114. The hydraulic system 130 is a component that facilitates the controlled raising and lowering of the dump body 114, which is essential for efficient cargo unloading operations. The hydraulic system 130 includes a hydraulic pump. Driven by the dump vehicle 100's engine via a power take-off (PTO), this pump pressurizes the hydraulic fluid, serving as the hydraulic system's 130 power source. Further, the hydraulic system 130 includes a hydraulic reservoir. The hydraulic reservoir acts as a storage unit for hydraulic fluid. This tank also plays a role in heat dissipation and air bubble removal. In addition, the hydraulic system 130 includes control valves that precisely regulate the directional flow of hydraulic fluid, dictating the dump body's upward or downward movement. The hydraulic system 130 also includes hydraulic cylinders, which function as linear actuators. These cylinders translate hydraulic pressure into the mechanical force required to lift and lower the dump body 114. To connect each of the components, the hydraulic system 130 uses a network of hydraulic lines, hoses and fluid flow regulation valves that facilitate fluid transmission. Using these components, the hydraulic system 130 can elevate or lower the dump body 114 using the hoist actuator 112. The pressure difference caused by pumping hydraulic fluid into the hoist actuator 112 pushes one end of the dump body 114 creating the angle (Θ) 118. Material within the dump body 114 then rolls or slides out the back of the dump body 114. The dump body 114 is in a lowered position when the angle (Θ) 118 is at zero degrees. In some embodiments, the dump body 114 is in the lowered position when angle (Θ)) 118 is near zero, such as less than three degrees.

The hoist actuator 112 may include a valve that operates to selectively allow the hydraulic fluid to flow and use the change in pressure to cause the hoist 132 to expand and lift the dump body 114. In some examples, operation of the valve (i.e., a position of the valve) is controlled by air pressure. The air pressure is in turn controlled by a pneumatic actuator. The control system 110 generates signals that adjust the pressure output of the pneumatic actuator to operate the pneumatic valve and thereby move the valve to the desired position (e.g., closed to prevent further raising of the dump body, or open to further raise the dump body). When the height interlock is triggered, the hoist actuator 112 receives a controller generated signal that prevents the pneumatic actuator from opening the valve, thereby preventing pressurized hydraulic fluid flow into the hoist 132 and preventing further raising of the dump body.

As already described, the control system 110 controls functions of the dump vehicle. In some embodiments, the control system 110 controls the hydraulic system 130 and the hoist actuator 112. For example, the control system 110 may receive input to raise the dump body 114. The control system 110 then provides a signal to the hydraulic system 130 and/or the hoist actuator 112 to cause the hoist 132 to lift the dump body 114. The control system 110 may determine whether the height (H2) 126 will exceed a predetermined height if it continues rising. Responsive to determining the height (H2) 126 will exceed the predetermined height, the control system 110 generates a height interlock signal that causes the hydraulic system 130 and the hoist actuator 112 to cease raising the dump body 114.

The predetermined height may be selected to ensure the height (H2) 126 is below any potential hazards. In some embodiments, the predetermined height is a minimum clearance height of a location minus a safety factor. In some embodiments, the safety factor is two feet, three feet, five feet, or any necessary distance to increase the probability of the dump vehicle 100 does not contact the overhead hazard.

In some embodiments, the control system 110 monitors and controls the speed of the dump vehicle 100. For example, the control system 110 may determine a position of the dump body 114. If the control system 110 determines that the dump body 114 is in a raised position or above a second predetermined height, the control system 110 limits the speed of the dump vehicle 100. If the dump vehicle 100 attempts to accelerate, the control system 110 prevents the dump vehicle from exceeding a predetermined speed, thereby reminding the driver that the dump body is still in a raised and unsafe position.

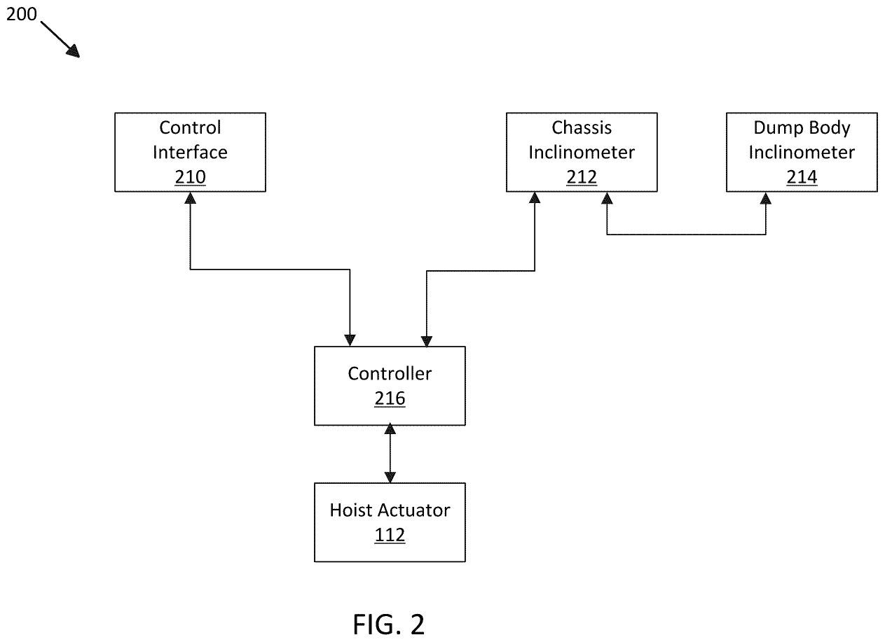

FIG. 2 depicts a block diagram of an example embodiment 200 of the control system 110. In this embodiment, the control system 200 includes a control interface 210, a chassis inclinometer 212, a dump body inclinometer 214, and a controller 216. The controller 216 connects to the hoist actuator 112. In some embodiments, the control system 200 may be the control system 110.

The control interface 210 receives input for controlling components of the dump vehicle 100, such as the control system 200, the hydraulic system 130, or the hoist actuator 112. The control interface may receive input to actuate functions of the dump body 114 such as raising and lowering the dump body 114. Further, the control interface 210 may be configured to receive input to program the controller 216. For example, the control interface 210 may receive input, which is provided to the controller 216, that indicates the predetermined maximum height for avoiding hazards or the predetermined speed while the dump body 114 is in a raised position. The control interface also sends signals based on received input to the controller 216 to actuate functions of the dump vehicle 100.

In addition, the control interface 210 may also include a display. The display of the control interface 210 may show many different parameters, statuses, and components to a user. For example, the display may show the current position of angle (Θ) 118. In addition, the display may indicate the current height (H2) 126 of the dump vehicle 100 with the dump body 114 raised. This information can be used to determine statuses of the dump vehicle 100 and if the dump vehicle 100 is operating safely. In some embodiments, the control interface receives the dump body 114 dimensions, such as the length (L) 122 and the height (H1) 124, from the manufacturer. In some embodiments, the control interface 210 receives input to set a predetermined height for a specific location or time duration. The predetermined height can then be changed at a later time.

The chassis inclinometer 212 senses an angle of the chassis 116 relative to gravity. The control system 200 can determine how the chassis is angled relative to flat ground using the chassis inclinometer 212. This angle can be used to determine a height of the dump body 114 and total height for the dump vehicle 100. The sensed angle is provided to the controller 216. The chassis inclinometer 212 may be an instrument used to measure the angle of tilt or inclination of an object or surface relative to gravity's direction. That is, the chassis inclinometer indicates how much the chassis 116 is tilted or sloped. Inclinometers may also be referred to as tilt meters, tilt sensors, slope gauges, or gradient meters. In some embodiments, the chassis inclinometer may be accelerometer-based or pendulum-based. Accelerometer-based inclinometers sense the changes in acceleration due to tilt, and then convert these readings into tilt angles. Pendulum-based inclinometers use a pendulum or a hanging mass that moves when the device is tilted. The movement is measured to determine the tilt angle. In some embodiments, the chassis inclinometer 212 uses a gyroscope-based sensor. Gyroscope-based sensors can help stabilize the readings from other sensors, especially in dynamic environments where vibrations or rapid movements can introduce errors. In some embodiments, the chassis inclinometer 212 monitors the chassis angle in a longitudinal direction and a lateral direction. For example, the chassis inclinometer 212 may measure a first angle in the longitudinal direction (i.e., the angle created as the length of the chassis tilts) and a second angle in the lateral direction (i.e., the angle created as the width of the chassis tilts). The longitudinal direction parallels the X axis and the long side of the chassis 116. The lateral direction parallels the Z direction (not shown) and the width of the dump vehicle 100.

The dump body inclinometer 214 senses an angle of the dump body relative to gravity. The control system 200 can use the sensed angle to determine a position of the dump body 114 and calculate a total height (H2) 126 of the dump vehicle 100. The sensed angle may be provided to the controller 216. In some embodiments, the dump body inclinometer first provides the angle to the chassis inclinometer 212, which then forwards the angle to the controller 216. In some embodiments, the dump body inclinometer 214 may be any of the sensor or inclinometer types discussed in relation to the chassis inclinometer. For example, the dump body inclinometer 214 may be acceleration based, pendulum-based, or include a gyroscope-based sensor. In some embodiments, the dump body inclinometer 214 monitors dump body angle in a longitudinal direction and a lateral direction. For example, the dump body inclinometer 212 may measure a first angle in the longitudinal direction (e.g., the angle created as the length of the dump body tilts) and a second angle in the lateral direction (e.g., the angle created as the width of the dump body tilts).

Example schematic mounting locations on the dump vehicle 100 for the chassis inclinometer 212 and the dump body inclinometer 214 are shown in FIG. 1, the two inclinometers being independently mounted to the chassis and dump body, respectively. In some examples, each of the chassis inclinometer 212 and the dump body inclinometer 214 includes a 3-axis incline sensor which reports master and slave position through a J1939 communication line. The master sensor can correspond to the chassis inclinometer 212 and can be mounted, e.g., on the chassis rail at the rear of the chassis. The slave sensor can correspond to the dump body inclinometer 214 and can be mounted at the rear of the body, near the hinge pin 136.

The sensors of the inclinometers 212 and 214 can function independently to separately monitor, in 3 axes, the chassis 116, and in the same 3 axes, the dump body 114. The sensors can function as a singular system to monitor the angular difference, for each of the 3 axes between the chassis 116 and the dump body 114, as described in more detail below.

The hoist actuator 112 connects to the controller 216. The controller 216 can provide the hoist actuator signals that cause the hoist 132 to expand using the hydraulic system 130 and raise the dump body 114. The signal from the controller 216 may control one or more valves that can let hydraulic fluid flow to raise the dump body 114, release hydraulic fluid so the dump body 114 lowers, or maintain pressure in the hoist 132 so the dump body 114 is held steady.

In this embodiment, the controller 216 monitors the height (H2) 126 of the dump vehicle 100. Further, the controller is communicatively connected to the control interface 210, the chassis inclinometer 212, and the hoist actuator 112 such that the controller 216 can receive and send signals that provide data and/or commands for controlling the indicated components or receiving data from the indicated components. In some embodiments, the controller 216 is communicatively connected to the dump body inclinometer 214.

The controller 216 calculates the height (H2) 126 of the dump vehicle 100. To perform this calculation, the controller 216 may first calculate the angle (Θ) 118. The controller 216 uses the received angle from the chassis inclinometer 212 and the received angle from the dump body inclinometer 214 to calculate the angle (Θ) 118. For example, the angle received from the chassis inclinometer 212 may be subtracted from the angle received from the dump body inclinometer 214 to obtain the angle (Θ) 118. Further, the controller 216 may have received the height (H1) 124, the height (F) 128, the distance (O) 120, and the length (L) 122 from the control interface 210 and/or from stored memory, as input.

Chassis inclinometer inclination angle measurements in multiple dimensions can be graphically displayed on the control interface 210 with dynamic graphical elements 910 and 912. Dump body inclinometer measurements can be graphically displayed on the control interface 210 using a graphical element showing a displayed angle 514.

In some embodiments, the controller 216 calculates the height (H2) 126 based on the height (F) 128 from the top of the chassis to ground, the height (H1) 124 from the bottom of the dump body to the top of the dump body, the length (L) 122 of the dump body, and the distance (O) 120 from a dump body pivot pin of the dump body to a floor panel of the dump body, and the angle (Θ) 118 from the dump body to the chassis obtained from the chassis inclinometer and the dump body inclinometer. In some embodiments, the controller 216 performs the calculation using the following formula:

$$H 2 = F + ( ( sin ( {tan}^{- 1} ( \frac{H 1}{L - O} ) + Δ θ ) * \sqrt{{( L - O )}^{2} + H {1}^{2}} ) )$$

The controller 216 also calculates the height (H2) 126 responsive to certain triggers. In some embodiments, the controller 216 calculates the height (H2) 126 continuously while the dump vehicle 100 is operational. In some embodiments, the controller 216 calculates the height (H2) 126 responsive to receiving a signal indicating input to raise the dump body 114.

In some embodiments, the controller 216 performs the functions of the interlock 134. For example, the controller 216 generates and provides a signal to the hoist actuator to pressurize the hydraulic line connected to the hoist 132, thus, controlling the raising and lowering of the hoist 132. The controller 216 may be programmed with the predetermined height limit. Responsive to determining the height (H2) 126 is at the predetermined height limit, the controller does not provide any additional signals to the hoist actuator 112 to cause the hoist 132 to increase the height of the dump body 114.

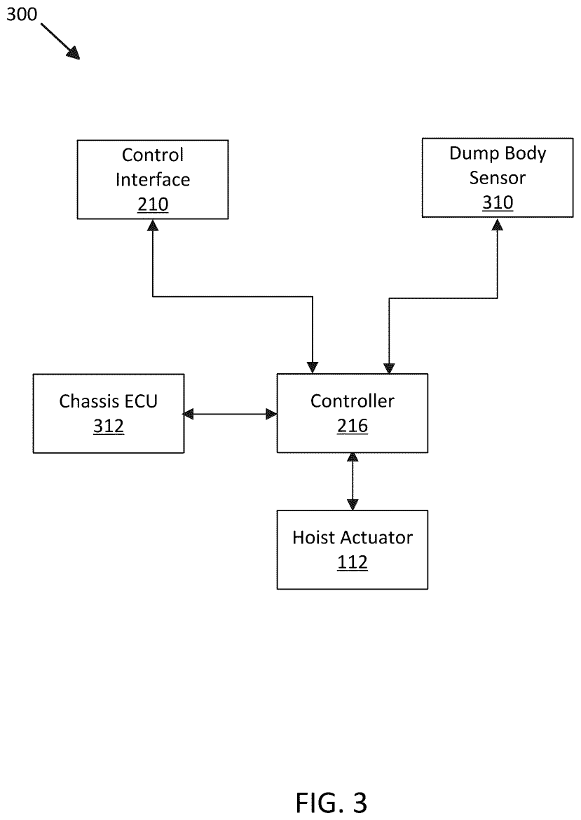

FIG. 3 depicts a block diagram of a second example embodiment 300 of the control system 110. In the shown embodiment, the controller 216 connects to a chassis ECU 312 and a dump body sensor 310. The controller connects to the shown components to limit a speed of the dump vehicle if the dump body 114 is in a raised position. In some embodiments, the control system 300 may be the control system 200.

It will be appreciated that the various embodiments and functionalities of the control system 300 as described herein, such as the components of FIG. 2 and the components of FIG. 3 can be combined into a single control system 300 that can be installed in a dump vehicle. In other examples, a control system having the functionality of just one of the control system embodiments herein, can be installed in a dump vehicle.

The dump body sensor 310 determines a position of the dump body 114. In some embodiments, the dump body sensor 310 may monitor the hoist 132. If the hoist 132 is raised, then the dump body sensor 310 determines the dump body 114 is raised. In some embodiments, the dump body sensor 310 determines if the dump body 114 is at a height greater than the second predetermined height. Whether the height of the dump body 114 exceeds the second predetermined height determines if the dump body 114 is in a raised position. In some embodiments, the dump body sensor 310 is the dump body inclinometer 214. The dump body sensor 310 senses an angle of the dump body 114 relative to gravity to determine if the dump body 114 is in a raised position. For example, the dump body 114 is in a raised position if the determined angle is greater than a predetermined angle (e.g., greater than 0 degrees, or greater than 2 degrees, or greater than 5 degrees). The second predetermined height and the predetermined angle may be input via the control interface 210 and/or stored in a memory that the controller 216 accesses.

In addition, the dump body sensor 310 informs the controller 216 of whether the dump body 114 is in a raised position. The dump body sensor 310 is communicatively connected to the controller 216. Further, the dump body sensor 310 provides signals to the controller 216 to indicate whether the dump body 114 is in a raised position. In some embodiments, the dump body sensor 310 provides the position of the dump body 114 to the controller 216. For example, the dump body sensor 310 may provide the angle (Θ) 118. The position of the dump body 114 can then be determined and displayed to an operator. In some embodiments, the dump body sensor 310 is a different kind of sensor.

The controller 216 determines whether the dump body 114 is in a raised position and, if so, the speed of the dump vehicle 100 is limited in response. In some embodiments, the controller 216 determines if the received position or angle of the dump body 114 exceeds the second predetermined height or the predetermined angle. Based on this determination, the controller 216 can determine if the dump body is in a raised position. If the dump body is in a raised position, the controller 216 limits the speed of the dump vehicle 100.

In some embodiments, the controller 216 connects to the chassis ECU 312. The controller 216 can exchange data with the chassis ECU 312 to cause the dump vehicle 100 to limit its speed. Limiting the speed of the dump vehicle 100 helps to remind the driver while the dump vehicle 100 is moving and the dump body 114 is raised. The controller 216 may provide a signal to the chassis ECU 312 to set a maximum speed of the dump vehicle 100. The maximum speed may be a predetermined speed. After the speed is limited, the dump vehicle 100 will not increase in speed even if the accelerator is engaged. Once the controller 216 determines the dump body 114 is in a lowered position, the controller 216 communicates to the chassis ECU 312 that the dump vehicle can accelerate as in normal operation. In some embodiments, the controller 216 may determine the dump body 114 is in the lowered position based on a received position or angle from the dump body sensor 310.

In some embodiments, the controller 216 connects to the chassis ECU 312 through a control area network (CAN) connection. A CAN is a robust and efficient communication protocol primarily used in vehicles and industrial automation. The CAN allows various electronic devices, or nodes, to communicate with each other without the need for a central host computer. Further, the CAN may connect to other components of the dump vehicle 100 such as the engine, brakes, airbags, and an entertainment system.

In some embodiments, the chassis ECU 312 is a chassis domain controller that consolidates many ECUs, such as brake control modules, steering control modules, suspension control module, tire pressure monitoring systems module, engine control module (ECM), transmission control module (TCM), or an airbag control module, into a single ECU. In some embodiments, the chassis ECU 312 is multiple ECUs for communicating with different components of the dump vehicle 100.

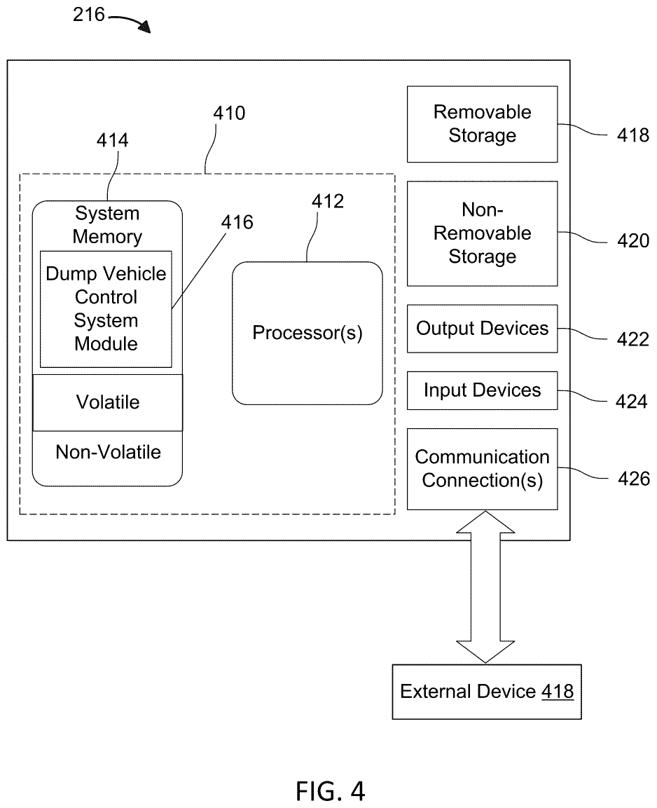

FIG. 4 depicts a block diagram of example components of the controller 216. In the shown embodiment, the controller 216 includes components 410, which includes one or more processors 412 coupled to system memory 414. System memory includes the dump vehicle control system module 416. The controller 216 also includes one or more communication connections 426, which communicatively connects to external devices 418.

The one or more processors 412 couples to the system memory 414. The system memory 414 may include non-transitory computer readable medium. In some embodiments, the system memory 414 (storing, among other things, the dump vehicle control system module 416) can be volatile (such as RAM), non-volatile (such as ROM, flash memory, etc.), or some combination of the two. The controller 216 may include one or more graphics processing units (GPUs), application specific integrated circuit (ASIC), or other integrated circuit (IC) configured to perform the previously described functions. Further, the controller 216 may also include storage devices (removable storage device 418, and/or non-removable storage device 420) including, but not limited to, solid-state devices, magnetic or optical disks, or tape. Further, controller 216 may also have input device(s) 424 such as touch screens, keyboard, mouse, pen, voice input, etc., and/or output device(s) 422 such as one or more field programmable gate arrays. One or more communication connection(s) 246, such as local-area network (LAN), wide-area network (WAN), point-to-point, Bluetooth, RF, etc., may also be incorporated into the controller 216. In some embodiments, the communication connection(s) 426 connect to one or more external devices 418 such as the control interface 210, the chassis inclinometer 212, the dump body inclinometer 214, the hoist actuator 112, the dump body sensor 310, and/or the chassis ECU 312. In some embodiments, communication connection(s) is a wired or wireless connection.

In some embodiments, the dump vehicle control system module 416 includes instructions that cause the one or more processors 412 to perform operations. In some embodiments, the instructions include monitoring a height of the dump body 114 so the height (H2) 126 does not exceed a predetermined height. In some embodiments, the instructions include determining if the dump body 114 is in a raised position, and then limiting the speed of the dump vehicle 100 based on the determination.

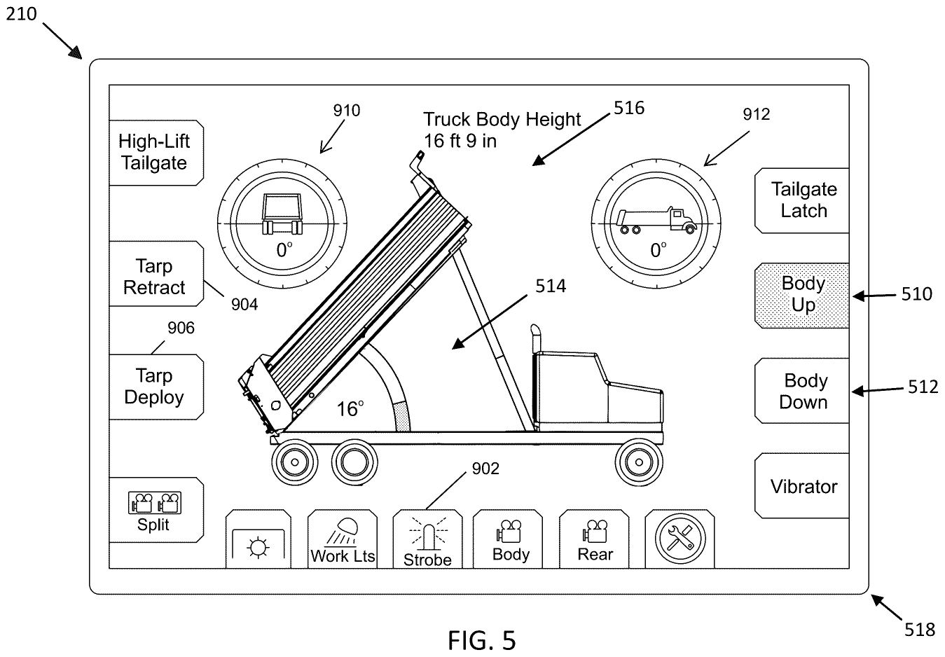

FIG. 5 depicts an example control interface 210 for providing input to the control system 110. In this embodiment, the control interface 210 includes a body up input 510, a body down input 512, a displayed angle 514 indicating the angle (Θ) 118 of the dump body 114 relative to the chassis 116, a displayed height 516 indicating the height (H2) 126 of the dump vehicle 100, and other inputs 518.

The body up input 510 and the body down input 512 control the height of the dump body 114. Receiving input by the body up input 510 causes the dump body 114 to increase in height. Receiving input by the body down input 512 causes the dump body 114 to decrease in height. In some embodiments, preset heights for the dump body are included with the control interface 210.

The displayed angle 514 shows the current calculated angle (Θ) 118 of the dump body 114 relative to the chassis 116. The displayed height 516 shows the current calculated height (H2) 126 of the dump vehicle 100. In some embodiments, the displayed angle 514 and the displayed height 516 are color coded. For example, the displayed angle 514 or the displayed height 516 may be green to indicate the height (H2) 126 is below a predetermined height to ensure the dump vehicle 100 avoids any potential hazards. In some embodiments, the control interface 210 may display warnings. The warnings may include a text pop up that indicates that the dump body 114 cannot be further raised. In addition, the warnings may include flashing indicators and/or audible alarms to further obtain the attention of an operator.

The other inputs 518 include controls for additional features of the dump vehicle 100. For example, the other inputs 518 may include a tarp retract that controls a tarp that covers material in the dump body 114. In some embodiments, the other inputs 518 include lights that can be turned on to illuminate the interior of the dump body 114. Other possible inputs may be included as well.

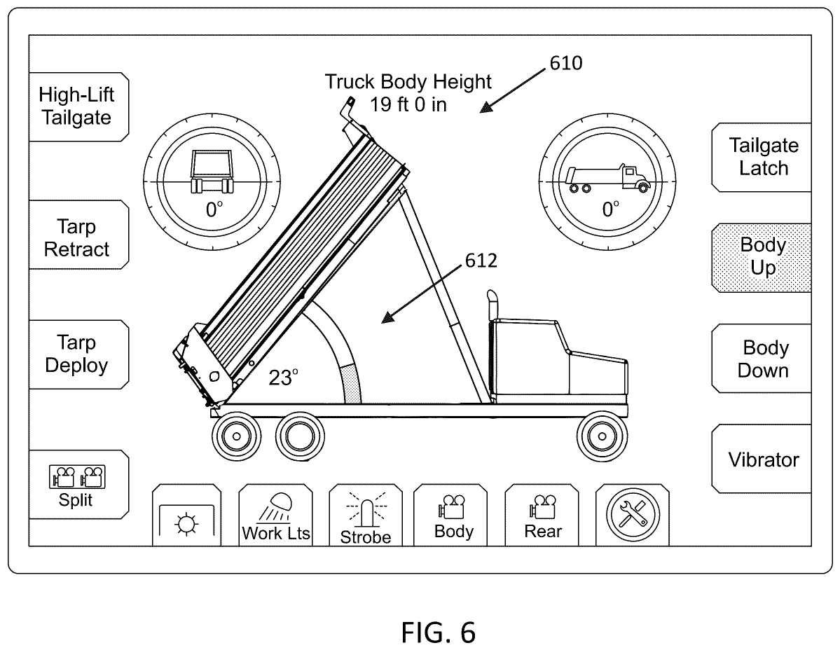

FIG. 6 depicts a second example display of the control interface 210 for providing input to the control system 110. In the shown embodiment, the control interface 210 shows the displayed height 610 and a displayed angle 612. Here, the displayed height is color coded to indicate (e.g., colored red) to indicate the dump body 114 will not further increase in height. Even if an operator presses the body up input 510, the dump height will not increase in height.

In some embodiments, the control interface 210 shown in FIG. 5 and FIG. 6 is located on the dump vehicle 100. The control interface 210 may be located within a cab of the dump vehicle 100. In some embodiments, the control interface 210 may be located on a side of the dump vehicle 100. The control interface 210 can be located where an operator can conveniently interact with it. Further, the control interface 210 may have a different display than the displays shown in association with FIG. 5 and FIG. 6.

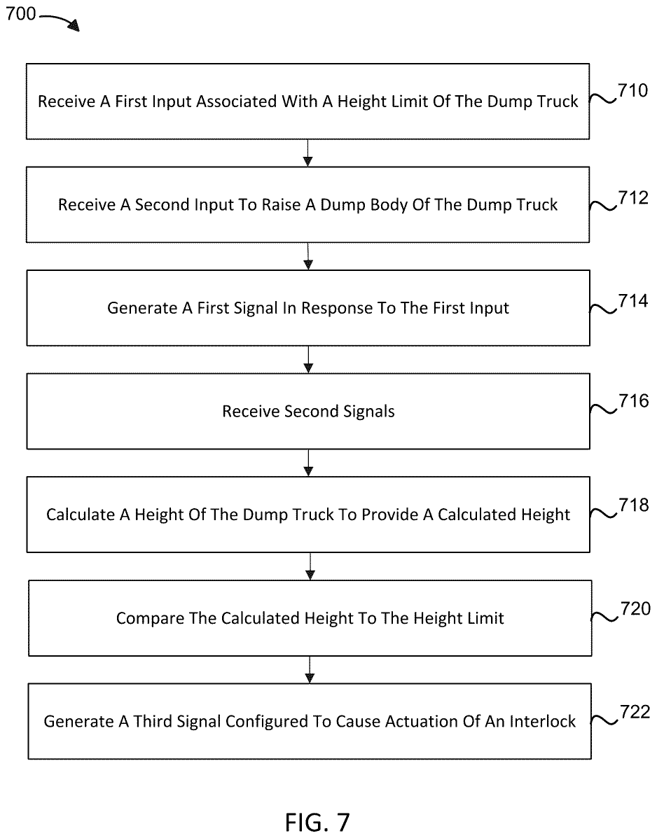

FIG. 7 depicts an example method 700 for controlling the height of the dump body 114 of the dump vehicle 100. In this embodiment, the method 700 includes a step 710, a step 712, a step 714, a step 716, a step 718, a step 720, and a step 722. In some embodiments, the method 700 may include additional steps or omit some of the shown steps. Further, the control system 110 or the controller 216 may perform some or all of the steps of the method 700.

At the step 710 of the method 700, a first input associated with a height limit of the dump truck is received. For example, the control system 110 may receive input at the control interface 210. The input may set a maximum height for the height (H2) 126.

At the step 712 of the method 700, the step 712 includes receiving a second input to raise a dump body of the dump truck. The input may be to raise the height (H2) 126 of the dump body 114. This input may cause the angle (Θ) 118 to increase. In some embodiments, the second input is received from the control interface 210.

At the step 714 of the method 700, a first signal is generated in response to the first input. The first signal is configured to cause a hoist of the dump truck to raise the dump body of the dump truck. For example, the controller 216 may provide the signal to the hoist actuator 112 to cause the hoist 132 to expand and raise up the one side of the dump body 114.

At the step 716 of the method 700, second signals are received. The second signals may be received from the chassis inclinometer 212 and the dump body inclinometer 214. The chassis inclinometer 212 may provide a signal indicating a first angle, and the dump body inclinometer 214 may provide a signal indicating a second angle.

At the step 718 of the method 700, a height of the dump truck is calculated to provide a calculated height. Continuing the previous example, the controller 216 calculates the height (H2) 126 of the dump vehicle 100 from the dump body 114 increasing in height. In some embodiments, the calculated height (H2) 126 is calculated based on an angle received from a chassis inclinometer and a second angle received from a dump body inclinometer.

At the step 720 of the method 700, the calculated height is compared to the height limit. For example, the controller 216 may determine if the height (H2) 126 is at or above the predetermined height by comparing the calculated height (H2) 126 to the predetermined height. In some embodiments, the control system 110 may notify the operator that the height (H2) 126 of the dump vehicle has reached the predetermined height. Further, the notification may include a message that the dump body 114 will not rise any more.

At the step 722 of the method 700,a third signal configured to cause actuation of an interlock is generated. The interlock prevents further raising of the dump body by the hoist. For example, the controller 216 may send a signal to the hoist actuator 112 to stop expanding the hoist 132 so the height (H2) 126 remains at or below the predetermined height. This limit helps prevent the dump vehicle 100 from contacting an overhead hazard. In some embodiments, the controller 216 provides the signal responsive to a determination that the resulting height is at or above the predetermined height.

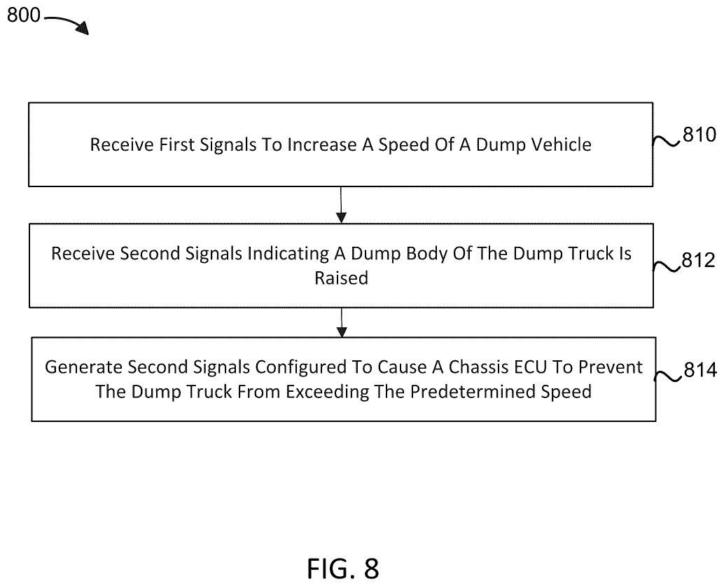

FIG. 8 depicts an example method 800 for controlling the speed of the dump body 114 of the dump vehicle 100. In this embodiment, the method 800 includes a step 810, a step 812, and a step 814. In some embodiments, the method 800 may include additional steps or omit some of the shown steps. Further, the control system 110 or the controller 216 may perform some or all of the steps of the method 800.

At the step 810 of the method 800, first signals to increase a speed of a dump vehicle are received. The first signals may be received from the chassis ECU 312. The chassis ECU 312 provides the signal to indicate that the truck is being accelerated. For example, the control system 110 may receive input in the form of an operator pressing the accelerator to increase the speed of the dump vehicle 100.

At the step 812 of the method 800, second signals indicating a dump body of the dump truck is raised are received. The second signals may be received from the dump body sensor 310. In some embodiments, the step 812 includes determining a position of a dump body of the dump truck. For example, the controller 216 may receive a signal from the dump body sensor 310 indicating the dump body 114 is in a raised position. In some embodiments, the controller receives a height or an angle from the dump body sensor 310.

In some embodiments, the step 812 includes determining the position exceeds a predetermined height. For example, the dump body 114 may be raised by the hoist 132. In some embodiments, the controller 216 determines if the dump body 114 is in a raised position. In some embodiments, the dump body sensor 310 determines if the dump body 114 is fully lowered or in a raised position based on detecting the presence of the dump body 114 being fully lowered, such as two ends of a sensor being connected.

At the step 814 of the method 800, second signals configured to cause a chassis ECU to prevent the dump truck from exceeding the predetermined speed are generated. In some embodiments, the chassis ECU 312 controls the speed of the dump truck. In some embodiments, the step 814 includes increasing the speed of the dump vehicle until it reaches a predetermined speed limit. The controller 216 may communicate to the chassis ECU 312 that the dump vehicle 100 cannot exceed a predetermined speed. Thus, the speed of the dump vehicle 100 is limited while the dump body 114 is determined to be in a raised position. This limit on speed helps to remind the driver that the dump body is still in a raised and unsafe position.

In some embodiments, the method 800 further includes determining the dump body 114 is in a lowered position. The method 800 may further include providing a signal to the chassis ECU 312 that the speed should no longer be limited to the predetermined speed responsive to the determination of the dump body being in a lowered position. The method 800 may further include increasing the speed of the dump vehicle 100 above the predetermined speed responsive to determining the dump body 114 is in the lowered position.

Additional features and functions of the dump vehicle 100 and the control system 110 will now be described. These additional features and functions can be provided independently of each other, or combined in the same control system, as well as independently of, or combined with, one or more of the various other functions and features of the control systems described herein.

For example, in a further embodiment of the control system 110, a strobe light interlock is provided whereby a strobe light of the dump vehicle can be configured to automatically shut off when the chassis of the dump vehicle 100 reaches a predefined speed.

Dump vehicles can be equipped with strobe lights in various locations on the exterior of the dump vehicle. The strobe lights can be legally required to flash when the dump vehicle is performing a hazardous operation, such as working in a construction zone on a road or stopped at the side of road. It can be unlawful, or otherwise undesirable, to have a strobe light activated in other situations, such as during ordinary travel along a highway. Dump vehicle operators may forget to deactivate a strobe light when leaving a worksite.

The controller 216 can be operatively linked, via one or more wires, or wirelessly, to an external strobe light of the dump vehicle 100. The controller 216 is also operatively linked to the chassis ECU 312. The controller 216 receives signals from the strobe light (e.g., the schematically represented strobe light 900 in FIG. 1) indicating that the strobe light is activated or deactivated. The controller 216 also receives signals from the ECU 312 indicating a speed of the chassis 116. The controller 216 is programmed to deactivate an activated strobe light 900 when the chassis 116 exceeds a threshold speed by turning off power to the strobe light 900 when the predefined speed condition is detected.

Using a further embodiment of the control interface 210, a user can set and adjust the threshold chassis speed at or above which the strobe light 900 will be automatically shut off by the controller 216 if the controller 216 detects that strobe light 900 is on. For example, the controller 216 can be programmed to automatically shut off the strobe light 900 at or above 30 miles per hour, or at or above 50 miles per hour, and the like.

Via a further embodiment of the control interface 210, the automatic strobe light shutoff function can also be disabled entirely, and re-enabled as desired. The control interface can also provide one or more interactive buttons (such as the button 902 in FIG. 5) for manual operation of the strobe light 900. In some examples, these buttons are automatically disabled by the controller 216 when the preset threshold speed of the chassis is exceeded, thereby preventing manual operation of the strobe light 900 at high speed. The controller 216 can be configured to automatically re-enable the button 902 when the speed reaches or drops below the threshold speed.

To perform these various strobe light control functions, the controller 216 is configured to communicate with the ECU through communication methods, such as an ECM and TCM J1939 protocol network.

In a further example of the control system 110, a tarp interlock is provided whereby control of a tarp driver of the dump vehicle 100 can be configured to be automatically disabled when the chassis of the dump vehicle 100 reaches a predefined speed. In different examples, the predefined speed for disabling the tarp driver can be set independently or codependently of the predefined speed that triggers automatic deactivation of the strobe light using the control interface.

Dump vehicles can be equipped with tarps. A tarp is used to cover a load in the dump body to minimize debris from the load escaping the body during transit. In certain dump vehicles, the tarp is driven by a motor that can be controlled from inside the cab to deploy or retract the tarp as needed by unrolling the tarp from a spool or rolling it up on the spool, with the motor driving rotation of the spool. For example, when the dump vehicle arrives at a work site, the tarp is retracted, and when the dump vehicle travels to another location carrying a load, the tarp is deployed.

It can be hazardous and/or illegal to operate the tarp during transit, e.g., when the dump vehicle is traveling at speed along a highway. Deploying or retracting the tarp in these conditions can damage the tarp (e.g., from wind) and other components of the dump truck, and potentially endanger nearby structures and vehicles if parts of the tarp system break off or detach.

Operators of dump vehicles may improperly attempt (e.g., to save time) to deploy or retract the tarp when the dump vehicle is travelling at a speed hazardous for that operation. Activation of the tarp can also occur accidentally at high speed, if the operator accidentally presses a button or flips a switch that deploys or retracts the tarp.

The controller 216 can be operatively linked, via one or more wires, or wirelessly, to the tarp driver 906 (schematically shown in FIG. 1) to deploy and retract the tarp upon receiving corresponding signals from the tarp deploy and tarp retract buttons 904 and 906 (FIG. 5) on the interface 210. The controller 216 is also operatively linked to the chassis ECU 312 and receives signals from the ECU 312 indicating a speed of the chassis 116. The controller 216 is programmed to deactivate the tarp retract and deploy buttons 904 and 906 on the interface 210 automatically when the chassis 116 exceeds a preset threshold speed, thus preventing the operator from deploying or retracting the tarp via the tarp driver 906 by pressing the buttons 904 and 906. The controller 216 can be configured to automatically re-enable the buttons 904 and 906 when the speed reaches or drops below the threshold speed.

Using a further embodiment of the control interface 210, a user can set and adjust the threshold chassis speed at or above which the buttons 904 and 906 automatically become disabled (and at or below they are re-enabled) by the controller 216. For example, the controller 216 can be programmed to automatically disable the buttons 904 and 906 at or above 30 miles per hour, or at or above 50 miles per hour, and the like. Via a further embodiment of the control interface 210, the automatic tarp disablement can be manually overridden (such that the buttons 904 and 906 remain enabled even at high speed), and re-enabled as desired.

To perform these various tarp control functions, the controller 216 is configured to communicate with the ECU through standard communication methods, such as an ECM and TCM J1939 protocol network.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A control system for a dump truck, the control system comprising:
a controller configured to:
receive a first input associated with a height limit of the dump truck;
receive a second input to raise a dump body of the dump truck;
generate a first signal in response to the first input, the first signal being configured to cause a hoist of the dump truck to raise the dump body of the dump truck;
receive second signals; and
based on the second signals:
calculate a height of the dump truck to provide a calculated height;
compare the calculated height to the height limit; and
when the calculated height reaches the height limit, generate a third signal configured to cause actuation of an interlock that prevents further raising of the dump body by the hoist.

2. The control system of claim 1, wherein the first input and the second input are received via an interface.

3. The control system of claim 1, wherein the second signals are generated by one or more sensors.

4. The control system of claim 3, wherein the one or more sensors include a chassis inclinometer and a dump body inclinometer.

5. The control system of claim 4, wherein the chassis inclinometer measures a first angle in a longitudinal direction and a second angle in a lateral direction of the dump truck, and the dump body inclinometer measures a third angle in the longitudinal direction and a fourth angle in the lateral direction of the dump truck.

6. The control system of claim 1, wherein the calculated height of the dump truck is calculated based on an angle between the dump body and a chassis of the dump truck.

7. The control system of claim 1, wherein the calculated height is calculated based on a first height (F) from a top of the chassis to ground, a second height (H1) from a bottom of the dump body to a top of the dump body, a length (L) of the dump body, a distance (O) from a pivot pin of the dump body to a floor panel of the dump body, and an angle (Θ) between the dump body and the chassis.

8. The control system of claim 7, wherein the calculated height (H2) of the dump truck is calculated based on a formula:
$$H 2 = F + ( ( sin ( {tan}^{- 1} ( \frac{H 1}{L - O} ) + Δ θ ) * \sqrt{{( L - O )}^{2} + H {1}^{2}} ) ) .$$

9. The control system of claim 1, wherein the controller is further configured to:
receive third signals indicating the dump body is raised; and
generate fourth signals, based on the third signals, to limit a speed of the dump truck to a predetermined speed limit.

10. The control system of claim 1, wherein the height limit is a minimum clearance height of a location minus a safety factor.

11. A dump truck, comprising:
a chassis;
a dump body;
a hoist configured to raise and lower a height of the dump body relative to the chassis;
a hoist actuator configured to selectively activate the hoist, the hoist actuator including an interlock;
a control interface;
a chassis inclinometer configured to indicate a first angle of the chassis of the dump truck relative to a direction of gravity;
a dump body inclinometer configured to indicate a second angle of the dump body of the dump truck relative to the direction of gravity;
a controller configured to:
receive, from the control interface, a first input associated with a height limit of the dump truck;
receive, from the control interface, a second input to raise the dump body of the dump truck;
generate a first signal in response to the second input, the first signal being configured to cause the hoist actuator of the dump truck to activate the hoist to raise the dump body of the dump truck;
receive second signals from the dump body inclinometer and the chassis inclinometer; and
based on the second signals:
calculate the height of the dump truck to provide a calculated height;
compare the calculated height to the height limit; and
when the calculated height reaches the height limit, generate a third signal configured to cause actuation of the interlock that prevents further raising of the dump body.

12. The dump truck of claim 11, wherein the chassis inclinometer measures a first angle in a longitudinal direction and a second angle in a lateral direction of the dump truck, and the dump body inclinometer measures a third angle in the longitudinal direction and a fourth angle in the lateral direction of the dump truck.

13. The dump truck of claim 11, wherein the calculated height of the dump truck is calculated based on an angle between the dump body and the chassis.

14. The dump truck of claim 11, wherein the calculated height is calculated based on a first height (F) from a top of the chassis to ground, a second height (H1) from a bottom of the dump body to a top of the dump body, a length (L) of the dump body, a distance (O) from a pivot pin of the dump body to a floor panel of the dump body, and an angle (Θ) between the dump body and the chassis.

15. The dump truck of claim 14, wherein the height (H2) of the dump truck is calculated by the controller based on a formula:
$$H 2 = F + ( ( sin ( {tan}^{- 1} ( \frac{H 1}{L - O} ) + Δ θ ) * \sqrt{{( L - O )}^{2} + H {1}^{2}} ) ) .$$

16. The dump truck of claim 11, further comprising:
a dump body sensor configured to generate third signals indicating the dump body of the dump truck is raised, wherein the controller provides fourth signals responsive to receiving the third signals; and
a chassis engine control unit (ECU) configured to receive the fourth signals from the controller and limit a speed of the dump truck to a predetermined speed limit responsive to receiving the fourth signals.

17. A control system for a dump truck, the control system comprising:
a controller configured to:
receive first signals indicating a dump body of the dump truck is raised; and
based on the first signals, generate second signals configured to cause a chassis engine control unit (ECU) of the dump truck to prevent the dump truck from exceeding a predetermined speed limit.

18. The control system of claim 17, wherein the controller is further configured to:
receive input indicating a maximum speed; and
based on the input, set the predetermined speed limit as the maximum speed.

19. The control system of claim 17, wherein the controller is further configured to:
receive third signals indicating the dump body is lowered; and
based on the third signals, generate fourth signals configured to cause the chassis ECU to allow acceleration of the dump truck above the predetermined speed limit.

20. The control system of claim 17, wherein the controller connects to the chassis ECU through a controller area network (CAN).

21. The control system of claim 4, wherein the control system is configured such that an inclination measured by the dump body inclinometer first provides a first sensed inclination to the chassis inclinometer and the chassis inclinometer then provides a second sensed inclination to the controller.

22. The control system of claim 17, comprising a chassis inclinometer and a dump body inclinometer,
wherein to generate the first signals, the control system is configured such that an inclination measured by the dump body inclinometer first provides a first sensed inclination to the chassis inclinometer and the chassis inclinometer then provides a second sensed inclination to the controller, the second sensed inclination being calculated by subtracting a first angle determined by the chassis inclinometer from a second angle determined by the dump body inclinometer.
